(19) United States
(12) Patent Application Publication
(10) Pub. No.: US 2021/0110330 A1
(43) Pub. Date: Apr. 15, 2021

(54) SKILL-SET SCORE BASED INTELLIGENT CASE ASSIGNMENT SYSTEM

(71) Applicant: Citrix Systems, Inc., Fort Lauderdale, FL (US)

(72) Inventors: Qiming Li, Nanjing (CN); Shengchi Zhang, Nanjing (CN)

(21) Appl. No.: 16/653,384

(22) Filed: Oct. 15, 2019

(51) Int. Cl. G06Q 10/06

(52) U.S. Cl. CPC G06Q 10/063112; G06Q 10/06398

(57) ABSTRACT

Described embodiments provide systems and methods for routing cases using a skill score. A system receives a self-evaluation skill score of a user for each feature of one or more products for which the user provides support. The system identifies a number of support cases handled by the user. The system determines a case-based skill score of the user for each feature. The system determines a skill score of the user for each feature based on at least the self-evaluation skill score of the user for each feature and the case-based skill score of the user for each feature. The system selects, responsive to receiving a request for support, the user from a plurality of users to support the request based at least on the skill score of the user for the feature. The system routes the request to the user.

### FIELD OF THE DISCLOSURE

This application generally relates to an intelligent case assignment system that uses skill-set scores to assign cases. For example, systems and methods of this disclosure are directed to determining a skill score for routing support cases.

### BACKGROUND

Information technology infrastructure can include server computing devices, intermediary computing devices, and endpoint computing devices communicating with one another over a network to provide various computing resources or services. Each of these devices can include hardware and software that are configured to perform one or more functions. The devices can be maintained or monitored over time to address failures, provide upgrades, or perform other services to improve the information technology infrastructure. However, due to the increasing number of information technology devices associated with a network or infrastructure, and the complexity associated with setup, configuration, or maintenance of the information technology devices, it can be challenging to effectively and efficiently support information technology devices.

### SUMMARY

This Summary is provided to introduce a selection of concepts in a simplified form that are further described below in the Detailed Description. This Summary is not intended to identify key features or essential features, nor is it intended to limit the scope of the claims included herewith.

This disclosure is directed to systems and methods for determining a skill score for routing support cases for information technology infrastructure and devices. Due to the various types of information technology devices, and the increasing complexity associated with features provided by the devices, it can be challenging to provide effectively and efficiently resolve faults or provide other maintenance or support for hardware or software associated with the devices. Systems and methods of this technical solution can provide a skill-set score based intelligent case assignment system. The system can determine, for each support engineer, a skill score for each feature of a product (e.g., computing device, application, service, or other resource). The system can determine the skill score for each feature of the product based on input from each support engineer, an audit of the support engineers, as well as based on feedback associated with one or more cases previously handled by each support engineer. Using the skill score for the support engineers, the system can match a support engineer with a new case received via a web interface. For example, the system can select the support engineer having the highest skill score associated with a feature indicated in the case. The system can then assign the selected support engineer to work on the case. Since the support engineer assigned to work on the case may have the highest skill score associated with the feature of the product of the case, the system can reduce inefficiencies associated with resolving the case, reduce delay associated with the resolving the case, or otherwise reduce resource consumption associated with resolving the case, thereby improving the functioning of the information technology infrastructure.

At least one aspect of this technical solution is directed to a method for determining a skill score for routing support cases. The method can include a device receiving, via a user interface, a self-evaluation skill score of a user for each feature of a plurality of features of one or more products for which the user provides support. The method can include the device identifying a number of support cases handled by the user from a plurality of support cases handled by a plurality of users. The number of support cases identified by the device can include each feature and have a status of closed. The method can include the device determining a case-based skill score of the user for each feature based at least on the number of support cases that are closed by the user for each feature. The method can include the device determining a skill score of the user for each feature based on at least the self-evaluation skill score of the user for each feature and the case-based skill score of the user for each feature. The method can include the device selecting, responsive to receiving a request for support on a product of the one or more products with a feature of the plurality of features, the user from a plurality of users to support the request based at least on the skill score of the user for the feature. The method can include the device routing the request to the user.

In some embodiments, the device can receive, via the user interface, one of a confirmation or a modification of the self-evaluation skill score of the user for each feature as a result of an audit of the self-evaluation score of the user by a second user. The user can be one of a support engineer or a technical support person, and the second user can be one of a supervisor or a technical lead to the user. The case-based skill score for each feature can be increased by an increase in the number of cases comprising the feature closed by the user.

The device can receive a customer-based skill score of the user for the customer from the customer associated with the request. The customer-based skill score can be received via an electronic-based survey presented to the customer responsive to closing the case. The device can update the skill score of the user based at least on the customer-based skill score.

The device can select the user based on the skill score being higher than one or more skill scores of one or more other users of the plurality of users for the feature and availability of the user. The device can receive the request identifying the feature of the product selected by the customer from the plurality of features. The device can update the skill score of the user responsive to both the number of cases comprising the feature closed by the user and changes to the customer-based skill score received by customers associated with the number of cases.

At least one aspect is directed to a system for determining a skill score for routing support cases. The system can include a device having one or more processors coupled to memory. The device can receive, via a user interface, a self-evaluation skill score of a user for each feature of a plurality of features of one or more products for which the user provides support. The device can identify a number of support cases handled by the user from a plurality of support cases handled by a plurality of users and that comprise each feature and have a status of closed. The device can determine a case-based skill score of the user for each feature based at least on the number of support cases that are closed by the user for each feature. The device can determine a skill score of the user for each feature based on at least the self-evaluation skill score of the user for each feature and the case-based skill score of the user for each feature. The device can select, responsive to receiving a request for support on a product of the one or more products with a feature of the plurality of features, the user from a plurality of users to support the request based at least on the skill score of the user for the feature. The device can route the request to the user.

In some embodiments, the device can receive, via the user interface, one of a confirmation or a modification of the self-evaluation skill score of the user for each feature as a result of an audit of the self-evaluation score of the user by a second user. The user can be one of a support engineer or a technical support person and the second user is one of a supervisor or a technical lead to the user. The case-based skill score for each feature can be increased by an increase in the number of cases comprising the feature closed by the user.

The device can receive a customer-based skill score of the user for the customer from the customer associated with the request. The device can receive the customer-based skill score via an electronic-based survey presented to the customer responsive to closing the case. The device can update the skill score of the user based at least on the customer-based skill score.

The device can select the user based on the skill score being higher than one or more skill scores of one or more other users of the plurality of users for the feature and availability of the user. The device can receive the request identifying the feature of the product selected by the customer from the plurality of features. The device can update the skill score of the user responsive to both the number of cases comprising the feature closed by the user and changes to the customer-based skill score received by customers associated with the number of cases.

### BRIEF DESCRIPTION OF THE DRAWING FIGURES

Objects, aspects, features, and advantages of embodiments disclosed herein will become more fully apparent from the following detailed description, the appended claims, and the accompanying drawing figures in which like reference numerals identify similar or identical elements. Reference numerals that are introduced in the specification in association with a drawing figure may be repeated in one or more subsequent figures without additional description in the specification in order to provide context for other features, and not every element may be labeled in every figure. The drawing figures are not necessarily to scale, emphasis instead being placed upon illustrating embodiments, principles and concepts. The drawings are not intended to limit the scope of the claims included herewith.

FIG. 1A is a block diagram of embodiments of a computing device;

FIG. 1B is a block diagram depicting a computing environment comprising client device in communication with cloud service providers;

FIG. 2 depicts an example block diagram of a system for determining a skill score for routing support cases;

FIG. 3 depicts an example flow diagram of a method for determining a skill score for routing support cases;

FIG. 4 depicts an example flow diagram of a method for updating a skill score used for routing support cases;

FIG. 5 depicts an example block diagram of score legend, in accordance with an embodiment;

FIG. 6 depicts an example block diagram of a skill-set score for a support engineer; and

FIG. 7 depicts an example block diagram of a skill-set score for a support engineer.

### DETAILED DESCRIPTION

For purposes of reading the description of the various embodiments below, the following descriptions of the sections of the specification and their respective contents may be helpful:

This technical solution is directed to systems and methods for determining and using a skill score to route support cases for information technology infrastructure and devices. Due to the increasing number and complexity of hardware and software products and features associated with networked information technology devices, it can be challenging to efficiently and effectively provide support or maintenance for the various features of the products, thereby introducing delays in resolving technical issues, reducing runtime, or otherwise negatively impacting information technology infrastructure.

For example, an application delivery controller (ADC), which can refer to a computer network device in a data center, can facilitate performance of tasks performed by web accelerators to remove load from web servers or provide load balancing. ADCs can further provide features related to secure sockets layer (SSL) offload, web application firewall, NAT64, DNS64, proxy/reverse proxy, etc. Due to the increasing number and complexity of features provided by ADCs, it can be challenging to effectively and efficiently address errors, bugs, configuration, hardware failures or faults, software upgrades, setup, or other issues related to the devices.

Systems and methods of this technical solution can provide a skill-set score based intelligent case assignment system. The system can determine, for each user (e.g., a support engineer or technical support agent), a skill score for one or more features of one or more products (e.g., computing device, application, service, ADC, or other resource). The system can determine the skill score for each feature of the product based on input from each support engineer, an audit of the support engineers, and based on feedback associated with one or more cases previously handled by each support engineer. Using the skill score for the support engineers, the system can match a support engineer with a new case received via a web interface. For example, the system can select the support engineer having the highest skill score associated with a feature indicated in the case. The system can then assign the selected support engineer to work on the case. Since the support engineer assigned to work on the case may have the highest skill score associated with the feature of the product of the case, the system can reduce inefficiencies associated with resolving the case, reduce delay associated with the resolving the case, or otherwise reduce resource consumption associated with resolving the case, thereby improving the functioning of the information technology infrastructure. Thus, by efficiently and reliably selecting and assigning a support technician based on the support technician's skill score for a feature, this technical solution can improve efficiencies and effectiveness with resolving issues or maintaining information technology devices such as ADCs.

Section A describes a computing environment which may be useful for practicing embodiments described herein; and

Section B describes systems and methods for determining a skill score for routing support cases.

### A. Computing Environment

Prior to discussing the specifics of embodiments of the systems and methods of <>, it may be helpful to discuss the computing environments in which such embodiments may be deployed.

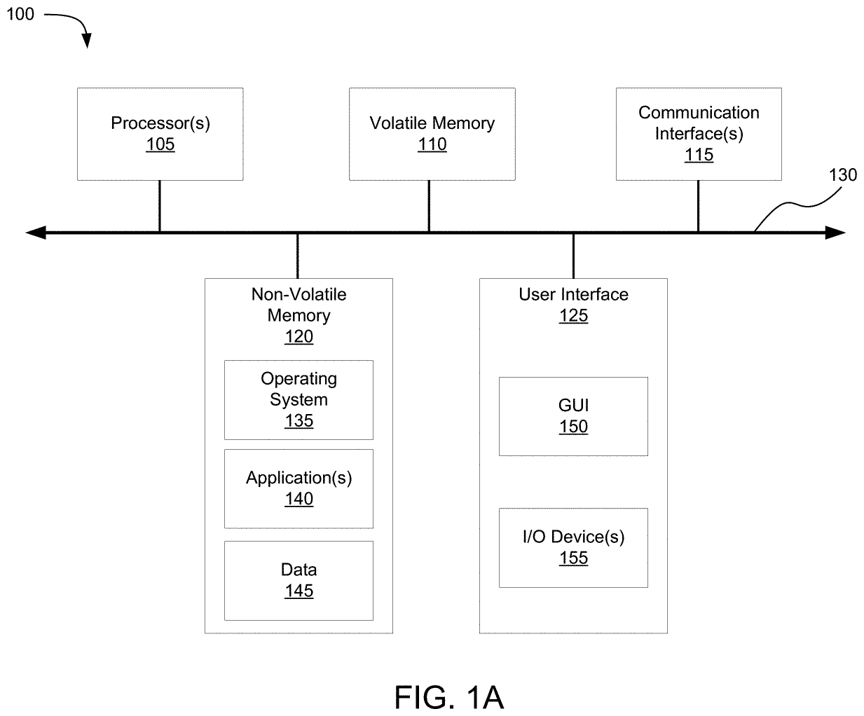

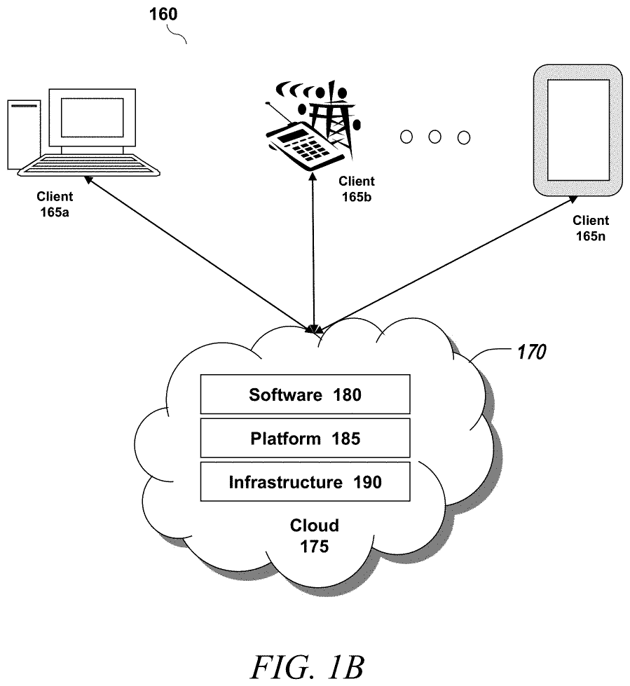

As shown in FIG. 1A, computer 100 may include one or more processors 105, volatile memory 110 (e.g., random access memory (RAM)), non-volatile memory 120 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 125, one or more communications interfaces 115, and communication bus 130. User interface 125 may include graphical user interface (GUI) 150 (e.g., a touchscreen, a display, etc.) and one or more input/output (I/O) devices 155 (e.g., a mouse, a keyboard, a microphone, one or more speakers, one or more cameras, one or more biometric scanners, one or more environmental sensors, one or more accelerometers, etc.). Non-volatile memory 120 stores operating system 135, one or more applications 140, and data 145 such that, for example, computer instructions of operating system 135 and/or applications 140 are executed by processor(s) 105 out of volatile memory 110. In some embodiments, volatile memory 110 may include one or more types of RAM and/or a cache memory that may offer a faster response time than a main memory. Data may be entered using an input device of GUI 150 or received from I/O device(s) 155. Various elements of computer 100 may communicate via one or more communication buses, shown as communication bus 130.

Computer 100 as shown in FIG. 1A is shown merely as an example, as clients, servers, intermediary and other networking devices and may be implemented by any computing or processing environment and with any type of machine or set of machines that may have suitable hardware and/or software capable of operating as described herein. Processor(s) 105 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A “processor” may perform the function, operation, or sequence of operations using digital values and/or using analog signals. In some embodiments, the “processor” can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors. A processor including multiple processor cores and/or multiple processors multiple processors may provide functionality for parallel, simultaneous execution of instructions or for parallel, simultaneous execution of one instruction on more than one piece of data.

Communications interfaces 115 may include one or more interfaces to enable computer 100 to access a computer network such as a Local Area Network (LAN), a Wide Area Network (WAN), a Personal Area Network (PAN), or the Internet through a variety of wired and/or wireless or cellular connections.

In described embodiments, the computing device 100 may execute an application on behalf of a user of a client computing device. For example, the computing device 100 may execute a virtual machine, which provides an execution session within which applications execute on behalf of a user or a client computing device, such as a hosted desktop session. The computing device 100 may also execute a terminal services session to provide a hosted desktop environment. The computing device 100 may provide access to a computing environment including one or more of: one or more applications, one or more desktop applications, and one or more desktop sessions in which one or more applications may execute.

Referring to FIG. 1B, a computing environment 160 is depicted. Computing environment 160 may generally be considered implemented as a cloud computing environment, an on-premises (“on-prem”) computing environment, or a hybrid computing environment including one or more on-prem computing environments and one or more cloud computing environments. When implemented as a cloud computing environment, also referred as a cloud environment, cloud computing or cloud network, computing environment 160 can provide the delivery of shared services (e.g., computer services) and shared resources (e.g., computer resources) to multiple users. For example, the computing environment 160 can include an environment or system for providing or delivering access to a plurality of shared services and resources to a plurality of users through the internet. The shared resources and services can include, but not limited to, networks, network bandwidth, servers, processing, memory, storage, applications, virtual machines, databases, software, hardware, analytics, and intelligence.

In embodiments, the computing environment 160 may provide client 165 with one or more resources provided by a network environment. The computing environment 165 may include one or more clients 165a-165n, in communication with a cloud 175 over one or more networks 170. Clients 165 may include, e.g., thick clients, thin clients, and zero clients. The cloud 175 may include back end platforms, e.g., servers, storage, server farms or data centers. The clients 165 can be the same as or substantially similar to computer 100 of FIG. 1A.

The users or clients 165 can correspond to a single organization or multiple organizations. For example, the computing environment 160 can include a private cloud serving a single organization (e.g., enterprise cloud). The computing environment 160 can include a community cloud or public cloud serving multiple organizations. In embodiments, the computing environment 160 can include a hybrid cloud that is a combination of a public cloud and a private cloud. For example, the cloud 175 may be public, private, or hybrid. Public clouds 175 may include public servers that are maintained by third parties to the clients 165 or the owners of the clients 165. The servers may be located off-site in remote geographical locations as disclosed above or otherwise. Public clouds 175 may be connected to the servers over a public network 170. Private clouds 175 may include private servers that are physically maintained by clients 165 or owners of clients 165. Private clouds 175 may be connected to the servers over a private network 170. Hybrid clouds 175 may include both the private and public networks 170 and servers.

The cloud 175 may include back end platforms, e.g., servers, storage, server farms or data centers. For example, the cloud 175 can include or correspond to a server or system remote from one or more clients 165 to provide third party control over a pool of shared services and resources. The computing environment 160 can provide resource pooling to serve multiple users via clients 165 through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In embodiments, the computing environment 160 can provide on-demand self-service to unilaterally provision computing capabilities (e.g., server time, network storage) across a network for multiple clients 165. The computing environment 160 can provide an elasticity to dynamically scale out or scale in responsive to different demands from one or more clients 165. In some embodiments, the computing environment 160 can include or provide monitoring services to monitor, control and/or generate reports corresponding to the provided shared services and resources.

In some embodiments, the computing environment 160 can include and provide different types of cloud computing services. For example, the computing environment 160 can include Infrastructure as a service (IaaS). The computing environment 160 can include Platform as a service (PaaS). The computing environment 160 can include serverless computing. The computing environment 160 can include Software as a service (SaaS). For example, the cloud 175 may also include a cloud based delivery, e.g. Software as a Service (SaaS) 180, Platform as a Service (PaaS) 185, and Infrastructure as a Service (IaaS) 190. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif. PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Clients 165 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP, and may use Representational State Transfer (REST) protocol or Simple Object Access Protocol (SOAP). Clients 165 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 165 may access SaaS resources through the use of web-based user interfaces, provided by a web browser (e.g. GOOGLE CHROME, Microsoft INTERNET EXPLORER, or Mozilla Firefox provided by Mozilla Foundation of Mountain View, Calif.). Clients 165 may also access SaaS resources through smartphone or tablet applications, including, e.g., Salesforce Sales Cloud, or Google Drive app. Clients 165 may also access SaaS resources through the client operating system, including, e.g., Windows file system for DROPBOX.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

### B. Systems and Methods For Determining a Skill Score for Routing Support Cases

This technical solution is directed towards systems and methods for determining a skill score for a support engineer based on calculated scores from customers and support engineer skill history. The skill score can be used to route support cases related to information technology infrastructure or devices.

For example, a system determines or calculates the skill score for each feature of the product that a support engineer is working on based on the case they handled, a survey or feedback from a customer, self-evaluation by the support engineer, and an audit from a technical lead engineer. The system can determine the skill score in one or more phases. In a first phase, the system can provide a user interface for the support engineer to perform a self-evaluation for each feature of a product. The support engineer can provide a skill score or fill out a survey via the user interface that the system can use to generate a self-evaluation skill score for the support engineer. In some cases, a second user (e.g., a technical lead or supervisor) can audit the self-evaluation skill score.

In a second phase, the system can calculate or determine a skill score for each feature for the support engineer based on information associated with closed cases for the support engineer and features included in the closed cases. The system can obtain the information from one or more sources, such as external sources such as a customer relationship management (CRM) system that manages customer data. The system can determine the skill score based on the number of closed cases containing the feature for the support engineer. The system can determine the skill score based on other factors or attributes associated with the closed cases, such as indications of performance or level of satisfaction of the customer associated with the case. The system can then combine the self-evaluation score with the skill score determined based on case closures to generate an initial score for the support engineer.

The system can then use the initial score to assign a support engineer to a case. For example, the system can receive a case from an end user or customer via an interface (e.g., a web interface, online system, or other system). The customer can select a specific feature on a product for the case. Responsive to receiving the case from the end user or customer, the system can determine to assign the case to a support engineer. To do so, the system can identify a feature of a product associated with the case. The system can determine a skill score (e.g., an initial score based on combining the self-evaluation-based score and the skill score determined based on closed cases having the feature) for the feature for each support engineer. In some cases, the system can identify available support engineers, and determine the skill score for the feature for the available support engineers. The system can then assign the case to the support engineer based on the skill score. For example, the system can assign the case to the support engineer who has the highest skill score for the feature associated with the case. If multiple support engineers are available and have the same skill score for a feature, the system can utilize a load balancing technique (e.g., round-robin) to select an available support engineer based on the skill score. Upon selecting the support engineer, the system can push the case to the selected support engineer to work on the case. Thus, this technical solution provides an intelligent system that assigns cases to support engineers based on the skill score of the support engineer for a feature of a product, thereby reducing delays in closing cases and providing improved technical support by assigning a support engineer with the highest skill score that is available to handle the case.

After the technical support engineer closes the case, the end user or customers can provide feedback on the support engineer's performance of the case. The feedback can include information about the skill level of the support engineer with regard to the feature of the product. The feedback can be provided via an online survey. The system can, responsive to receiving the feedback on the case, update the skill score for the feature for the support engineer. The system can update the skill score based on the increase in the number of cases closed by the support engineer having the feature of the product, as well as feedback from the customer. The system can generate charts or graphs that include detailed scores for each feature of the product for the support engineer, and a technical engineer lead can monitor or track skill scores for support engineers before or after case closures.

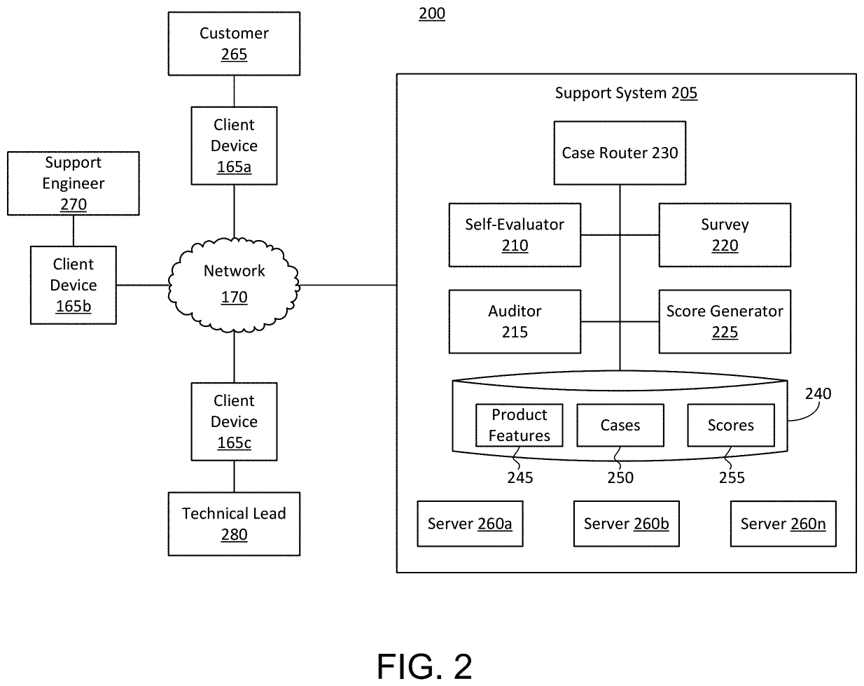

FIG. 2 depicts a block diagram of an example system for determining a skill score for routing support cases. The system 200 can determine a skill score for a support engineer based on calculated scores from customers and support engineer skill history, and route cases to support engineers based on the skill score. In brief overview, the system 200 can include a support system 205 (or device). The support system can communicate or interface with one or more client devices such as client devices 165a, 165b or 165c via a network 170. Client device 165a can be associated with a customer 265. Client device 165b can be associated with a support engineer 270. Client device 165c can be associated with a technical lead 280. The support system 205 can include or execute on one or more servers 260a, 260b, or 260n. The servers 260a-n can form part of, be included in, or refer to the cloud 175. The support system 205 can include one or more components configured to determine a skill score for routing support cases. For example, the support system 205 can include a self-evaluator 210 that provides a user interface to a support engineer 270 via a client device 165B to allow the support engineer 270 to self-evaluate their skill with regard to each feature of a product. The support system 205 can include an auditor 215 that allows a technical lead 280 to monitor the self-evaluation skill score provided by the support engineer 270 via the self-evaluator 210. The support system 205 can include a survey 220 configured to allow a customer 265 to provide feedback with regard to a feature of a case closed by the support engineer 270. The support system 205 can include a score generator 225 that can generate or update a skill score using one or more of the self-evaluation information provided by the self-evaluator 210, information provided by the technical lead 280 via auditor 215, information provided by the customer 265 via the survey 220, or other information or statistics associated with cases closed by the support engineer 270. The support system 205 can include a case router 230 that, responsive to detecting incoming case, identify available support engineers 270, select a support engineer 270 based on a skill score and a load balancing technique, and route or push a case to the support engineer 270.

The client device 165a, 165b or 165c can refer to or include one or more components of computing system 100 depicted in FIG. 1. The client device 165a, 165b or 165c can refer to or include one or more components of client devices 165a, 165b or 165n depicted in FIG. 1B. For example, the client devices 165a, 165b and 165c can include or communicate with a user interface 125, GUI 150, I/O devices 155 and communicate via a communication interface 115. The servers 260a-n can refer to or include one or more component or device depicted in FIGS. 1A-1B. The support system 205 can include or execute on one or more servers 260a-n or in a cloud 175 computing environment. A server 260a can refer to or include a computer 100 that provides data or services to another computer 100 or client devices 165a-n. One or more customers 265 can use or be associated with one or more client devices 165a. In some cases, each customer 265 can be associated with a different client device 165a. Customers 265 can utilize client devices 165a to interface with the support system 205, or one or more component thereof. For example, customers 265 can utilize client devices 165a to request a case, select a feature of a product for the case, and provide feedback upon case closure via a survey.

The support system 205 can interface or communicate with one or more support engineers 270 via one or more client devices 165b. Support engineers 270 can use client devices 165b to interface with the support system 205 or provide support. Support engineers 270 can input authentication credentials, such as a username and password, to access a client device 165b or access the support system 205. Support engineers 270 can be referred to as a first user or user. Support engineers 270 can be referred to as a technical support person, support technicians, or customer support. Client devices 165b can be configured with one or more protocols and applications that allow the support engineer 270 to access the support system 205 to interact with the self-evaluator 210. Client device 165b can be configured with one or more applications or protocols to receive, via the support system 205, a case. For example, the support system 205 can push a case to the client device 165b via network 170 responsive to selecting the support engineer 270 to work on the case.

The support system 205 can interface or communicate with one or more client devices 165c associated with one or more technical leads 280. The technical lead 280 can be referred to as a second user, auditor, supervisor, manager, monitor, or administrator. The technical lead 280 can be a technical lead or supervisor to the support engineer 270. The technical lead 280 can utilize client device 165c to access one or more component or functionality of the support system 205, including, for example, the auditor 215. The client devices 165c can be configured with one or more protocol or application configured to interface with the auditor 215 to perform an audit or monitor aspects of the support engineer 270.

The support system 205 can include one or more hardware or software components. The support system 205 can include one or more server, such as a server 260a, server 260b or server 260n. The support system 205 can include one or more component or functionality depicted in FIG. 1A and 1B, such as one or more component or functionality of computing system 100 or cloud 175. The support system 205 can include any type and form of application, system or platform that allows support engineers 270 to provide technical support for customers 265 using one or more information technology product. The support system 205 can include one or more applications, programs, libraries, scripts, services, tasks or executable instructions for providing the functionality and operations described herein.

The support system 205 can include a self-evaluator 210 designed, constructed and operational to receive, determine or identify a self-evaluation score of a user (e.g., support engineer 270) for one or more features of one or more products for which the support engineer 270 provides support. The self-evaluator 210 can access a data repository 240 storing one or more data structure or data files containing product features 245. Upon accessing the product features data structure 245, the self-evaluator 210 can generate or provide a user interface for rendering or execution on client device 165b to allow the support engineer 270 to perform a self-evaluation.

The product features 245 data structure can include a one or more products and one or more features of each of the one or more products. For each product, the product features 245 data structure can include a list or table of available features associated with the product. The product features data structure 245 can include an index, pointer, reference number, uniform resource locator or other identifier for the product and feature. The product features data structure 245 can include a unique identifier for each product. The product features data structure 245 can include a unique identifier for each feature of the product. The product features data structure 245 can include a link or association between features and products so as to uniquely identify a feature of a product.

Products can refer to or include information technology products, such as file servers, electronic message servers, client devices, server-side applications, client-side applications, gateways, load balancers, application delivery controllers, cloud management devices, or other hardware or software components associated with information technology infrastructure. Features can include or refer to functions, components, hardware, software or other aspects of the product, such as types of functions the product is configured to perform, or other aspects associated with the product.

For example, a product can include an application delivery controller (ADC). An ADC can refer to a computer network device in a data center that can facilitate the performance of tasks performed by web accelerators to remove load from web servers or provide load balancing. An ADC can include, provide or be associated with features such as authentication, certificates, cryptographic protocols such as transport layer security (TLS) or secure sockets layer (SSL), return merchandise authorization (RMA), high availability (HA), central processing unit (CPU), storage disk, memory, upgrade, downgrade, clustering, rewrite/responder, application firewall, level 2 switching, level 3 routing, level 4 load balancing, or core/crash.

In some cases, one or more features can be grouped together. For example, the CPU, storage disk, and memory features can be grouped together as a single feature. Grouping multiple features together into a single feature for the purpose of calculating a skill score can improve the efficiency with which the support system 205 can determine a skill score and route cases. The support system 205 can automatically group similar features together, or an administrator of the support system 205 can provide a grouping of features or list of features. The support system 205 can automatically group similar features together based on historical cases, based on common components or aspects of features, similarities of features or other products having similar functions and features, or other factors.

The self-evaluator 210 can receive a request from a support engineer 270 via client device 165b and network 170 to perform a self-evaluation. The request can include an account identifier (e.g., username) associated with the support engineer 270. The support system 205 can authenticate the support engineer 270 based on credentials (e.g., password, biometric credentials, multi-factor authentication, code, token, or key) associated with an account of the support engineer 270 stored in the support system 205.

The support system 205 can determine whether the support engineer 270 has already performed a self-evaluation, or if this is an initial self-evaluation. The support system 205 can determine whether the support engineer 270 has previously performed a self-evaluation for one or more products, and for which products the support engineer 270 has not performed a self-evaluation. The support engineer 270 can perform a lookup in the scores data structure 255 stored in data repository 240 to determine whether the support engineer 270 has already performed a self-evaluation for a product. For example, the scores data structure 255 can store self-evaluation scores for each product for the support engineer 270. The support system 205 can be configured to prevent the support engineer 270 from performing multiple self-evaluations on the same product so as to prevent potential fraudulent self-evaluation scores. The support system 205 can prevent multiple self-evaluation for the same product within a predetermined time frame, such as 1 week, 1 month, 2 months, 3 months, 6 months, 1 year or other time interval. By reducing, limiting, or controlling the number of self-evaluations that can be performed by a support engineer 270 for a given product, the support system 205 can reduce excessive network bandwidth utilization, processor utilization, or memory utilization of the system 200. By limiting or controlling the number of self-evaluations a support engineer 270 can perform for a particular product, the support system 205 can improve the reliability and accuracy of the self-evaluation score. By limiting or controlling the number of self-evaluations a support engineer 270 can perform for a particular product, the support system 205 can reduce resource waste and improve efficiencies by preventing the support engineer 270 from performing redundant or duplicative self-evaluations.

Responsive to receiving the request to initiate a self-evaluation process from the client device 165b, the self-evaluator 210 can identify a product for which to perform a self-evaluation. The self-evaluator 210 can automatically identify a product or the support engineer 270 can provide an indication of the product. If the request does not include a product identifier or other indication of a product, the self-evaluator 210 can select a product based on a predetermined list of products (e.g., product features data structure 245) or characteristics or attributes associated with the support engineer 270 (e.g., group, department, office location, geographic location, level, experience, historical cases, or profile information). The self-evaluator 210 can generate a list or menu of available products (e.g., via product features data structure 245) from which the support engineer 270 can select a product to begin self-evaluation. The self-evaluator 210 can generate a drop-down menu, table, list, or other user interface elements or widgets for rendering or display via client device 165b to allow the support engineer 270 to select a product for self-evaluation. In some cases, the request can include a product identifier (e.g., unique identifier, name, manufacturing company, model, version, year of release, application, configuration, computing environment, geographic location, etc.), such as an ADC or type of ADC.

Upon identifying a product for the self-evaluation, the self-evaluator 210 can begin a self-evaluation process. The self-evaluation process can be stored in data repository 240 along with product features 245. For example, each product features data structure 245 can include a self-evaluation process or test. The self-evaluator 210 can be configured with one or more types of self-evaluation processes or techniques. In some cases, the self-evaluation process can include generating one or more screens or user interface elements for each feature of each product. The self-evaluator 210 can perform a lookup in the product features 245 data structure to retrieve features associated with the identified product, and then generate one or more user interface elements for each feature of each product. For example, the self-evaluator 210 can generate a user interface element to allow a support engineer 270 to input, via client 165b, a score for each feature associated with the product. The self-evaluator 210 can generate or provide a rating system that includes one or more scores. The score can refer to a number, value, letter, alphanumeric character, symbol or other indicator of a level of skill at which the support engineer 270 can provide technical support for the feature of the product. The score can be a value within a range or spectrum, such as a numeric value between 1 and 10, or 1 and 200; a letter grade such as A, B, C, D, F; a word or term such as low, medium, or high; symbols such as emoticons that indicate level of skill; binary values such as good/bad or 0/1; or a spectrum of colors such as red, orange, yellow, green, for example. In some cases, 1 can refer to the highest skill level and 10 or 200 can refer to the lowest skill level; or 10 or 200 can refer to the highest skill level and 1 can refer to the lowest skill level. The score can be real number, whole numbers, integers, or include decimals. In some cases, the input field can include a null value or not application (N/A) which can indicate that the support engineer 270 has no experience with the feature, or is not aware of the feature.

In some cases, the self-evaluator 210 can generate or provide a questionnaire to allow the support engineer 270 to perform a self-evaluation. The questionnaire can include questions asking the support engineer 270 to rate or evaluate their level of skill with respect to a feature of a product. The questionnaire can include questions such as a test question that the self-evaluator 210 can analyze to determine a score. For example, the self-evaluator 210 can generate a quiz or test with questions and answers choices (e.g., a list of potential or candidate answers options that include right and wrong options) that the self-evaluator 210 can analyze to generate a score for the support engineer 270.

The self-evaluator 210 can generate and provide a user interface element containing an indication of the features of the product along with an input mechanism to allow the support engineer 270 to provide a score or rating for each feature of the product (or answer questions in a quick or questionnaire format). The self-evaluator 210 can receive input from the support engineer 270 via client device 165b and network 170. The self-evaluator 210 can analyze the input and generate a score for each feature of the product for the support engineer 270. The self-evaluator 210 can generate and store the self-evaluation score in a scores data structure 255 in data repository 240.

In some cases, the self-evaluator 210 can translate or normalize the input scores to generate a self-evaluation score. The self-evaluator 210 can normalize the scores based on a baseline or other benchmark. For example, the self-evaluator 210 can determine that scores or ratings provided by a user are statistically high and then normalize the score. The self-evaluator 210 can compare self-evaluation scores with other support engineers 270 with similar experience or history in order to normalize or modify the self-evaluation score. The self-evaluator 210 can be configured with a statistical process or analysis technique to generate the self-evaluation scores for each feature of each product for each support engineer 270. In some cases, the self-evaluator 210 can use the raw (e.g., unmodified or manipulated) input score for each feature as the self-evaluation score for the feature of the product of the support engineer 270.

The support system 205 can include an auditor 215 designed, constructed and operational to perform an audit or review of a self-evaluation score of a feature of a product generated based on a self-evaluation performed by the support engineer 270 via self-evaluator 210. The auditor 215 can be configured with one or more settings to perform an audit of the self-evaluation scores generated or provided via the self-evaluator 210. The auditor 215 can perform the audit or review process for each self-evaluation score for each feature of each product. The auditor 215 can determine to selectively perform the audit for a subset of the features of product. The auditor 215 can be configured with a predetermined list of features or products to audit or review (e.g., a predetermined list of features or products to audit stored in data repository 240 and provided by an administrator of the support system 205). The auditor 215 can perform an audit detection process to identify or select one or more self-evaluation scores, one or more features, or one or more products to audit based on various factors.

The auditor 215 can selectively perform an audit of one or more features of products based on an audit detection technique. For example, the auditor 215 can determine for a specific product or set of features of a product, the self-evaluation score varies from feedback provided by a customer 265 upon closing of a case associated with the feature. The auditor 215 can detect a discrepancy or statistical discrepancy between self-evaluations cores and other indications of skill level of features provided from other sources to determine that an audit of certain features is justified due to an increased likelihood of an error. For example, auditor 215 can determine, based on machine learning or a statistical model, that self-evaluation scores associated with a core/crash feature of an ADC product are higher than evaluation scores provided for the same feature upon case closure, thereby resulting in a later downgrade or decrease of the score. The auditor 215 can aggregate self-evaluation scores and customer scores associated with the same feature of the same product to determine a delta between self-evaluation scores and customer scores. For example, if the average self-evaluation score for feature A is greater than threshold (e.g., 3, 4, 5, 7, 8, 10, 15, 20 or more points, or a percentage such as 10%, 15%, 20%, 25%, or more) of an average customer provided score for feature A, then the auditor 215 can determine to flag feature A to be audited or reviewed by a technical lead 280. The threshold can be a dynamic threshold or a fixed threshold. The threshold can vary based on the feature or product. The threshold can vary based on the support engineer 270 or history of the support engineer 270. Thus, the auditor 215 can determine to perform an audit or review of each self-evaluation score for each feature of each product, or select a subset of self-evaluation scores of a subset of features of products, or each feature of a subset of products. Performing an audit of a subset of features or products based on an audit detection technique can reduce computing resource consumption, or network bandwidth utilization or other resource wastage while maintaining reliability and accuracy of the self-evaluation score and audit process.

Upon determining to audit self-evaluation scores of features of products, the auditor 215 can initiate an audit or review process. The auditor 215 can interface or communicate with a technical lead 280 via client device 165c to perform the audit or review process. For example, the auditor 215 can transmit self-evaluation scores for features of the product to client device 165c. Client device 165c can display the self-evaluation scores for features of the product provided by a support engineer 270. The client device 165c can display the self-evaluation scores via a user interface. The client device 165 can display the self-valuation scores in an electronic message, notification, window, pop-up window, web page, portal, or other application executing on the client device 165c. The auditor 215 can receive a request from the client device 165c to audit self-evaluation scores, perform an authentication process to authenticate or authorize the technical lead 280 based on authentication credentials of the technical lead 280, and transmit the self-evaluation scores responsive to authorization and authentication of the technical lead 280. In some cases, the auditor 215 can push the self-evaluation scores to the client device 165c responsive to the self-evaluator 210 generating or providing the self-evaluation scores to the auditor 215.

The auditor 215 can display a user interface that includes self-evaluation scores for features of products provided by the support engineer 270. The auditor 215 can receive an indication as to whether to approve or reject the self-evaluation score for each feature of the product. The auditor 215 can generate or provide a user interface element or button that allows the technical lead 280 to approve or reject the self-evaluation score. The auditor 215 can generate or provide a user interface element that allows the technical lead 280 to modify the self-evaluation score or provide a new score.

If the auditor 215 receives an indication to reject or deny a self-evaluation score of a product or feature, the auditor 215 can change the score, remove the score, set a default score, flag the score with an indication the technical lead 280 does not agree or rejects the self-evaluation score, or request the support engineer 270 that provided the score to provide a new self-evaluation score. The auditor 215 can, in some cases, transmit a request to the support engineer 270 to confirm the self-evaluation score or provide a different self-evaluation score for the feature. The auditor 215 can flag the self-evaluation score with an indication that the technical lead 280 approved the score or rejected the score (or other indication that the technical lead 280 does not agree with the score or indication that that the score is inaccurate or unreliable). The auditor 215 can store the results of the audit or review process in the scores data structure 255. The scores data structure 255 can include a data structure with fields: {support_engineer_identifier; product_identifier; feature_identifier; self-evaluation score; audit_flag or audit_value; case-based skill score; skill_score}. By auditing the self-evaluation scores, the support system 205 can improve the accuracy and reliability of the skill score for each feature of each product of the support engineer 270, thereby improving the performance of the case router 230 and causing an improvement in efficiency and efficacy of technical issue and case resolution.

The auditor 215 can receive one of a confirmation or a modification of the self-evaluation skill score of the support engineer 270. The auditor 215 can include a rating system similar to the rating system presented by the self-evaluator 210 to the support engineer 270. The auditor 215 can receive input from a technical lead engineer 280 that includes an examination of the accuracy of the self-evaluated skill score provided by the self-evaluator 210.

The support system 205 can include a score generator 225 designed, configured and operational to generate a score for a feature of a product for a user (e.g., support engineer 270). The score generator 225 can generate an initial score, an initial skill-set score, or update skill-set scores. The score generator 225 can determine one or more scores for the support engineer 270 based on various inputs or sources of input. The score generator 225 can generate a skill-set score based on one or more of a self-evaluation score provided via the self-evaluator 210, an audit provided via auditor 215, customer feedback provided by surveys 220, or case history received via case data structure 250.

The score generator 225 can generate a case-based skill score. The score generator 225 can generate, for a support engineer 270, the case-based skill score for each feature of a product. The score generator 225 can generate the case-based skill score based on various factors or information. For example, the score generator 225 can generate the case-based skill score based on historical case closures. The score generator 225 can determine the number of cases that were closed by the support engineer 270 that involved, contained or were associated with the feature of the product. The score generator 225 can determine that the greater the number of cases with the feature that were closed by the support engineer 270, the greater the case-based skill score for the feature for the support engineer 270.

To generate the case-based skill score, the score generator 225 can access a cases data structure 250 stored in data repository 240. The cases data structure 250 can be stored in data repository 240 of the support system 205, or the stored in a remote data repository of a third-party server, such as a CRM system external and remote from the support system 205. The cases data structure can include a time and date stamp the case was opened and closed, case status (e.g., open, closed, not yet started, pending, in process, etc.), an identifier of the support engineer 270, product identifier, or feature identifier. The cases data structure 250 can include additional information associated with the case, such as notes from support engineer 270, feedback from the customer 265, or duration (e.g., amount of time the support engineer 270 to resolve or close the case).

The score generator 225 can generate the case-based skill score for a feature of a product by performing a query, lookup or search in the cases data structure 250 with the identifier of the support engineer, identifier of the product and feature, and case status (e.g., closed). The score generator 225 can, responsive to the query, lookup or search, identify a number of cases containing the feature that were closed by the support engineer 270. The score generator 225 can set a value of the case-based skill score to be or correspond to the number of cases closed by the support engineer 270 containing the feature of the product. The score generator 225 can determine the case-based skill core based on function of the number of cases closed by the support engineer 270 containing the feature. For example, the score generator 225 can input the number of closed cases containing the feature into a function that outputs a case-based skill score. The score generator 225 can determine the case-based skill score as a ratio of case closures containing the feature over a time interval, such as a week, month, or year. The score generator 225 can determine the cased-based skill score based on a mapping of the number of closed cases containing the feature to a case-based skill score. Table 1 illustrates an example mapping of number of closed cases to a case-based skill score.

TABLE 1
Example map of number of closed cases to case-based skill score

| # Closed Cases | Case-Based Skill Score |
|---|---|
| Less than 10 | 0 |
| 10-19 | 1 |
| 20-29 | 2 |
| 30-39 | 3 |
| 40-49 | 4 |
| 50-59 | 5 |
| 60-69 | 6 |
| 70-79 | 7 |
| 80-89 | 8 |
| 90-99 | 9 |
| Greater than 200 | 10 |

The score generator 225 can generate the case-based skill score by identifying all cases closed by the support engineer 270 containing the feature, or cases closed within a time interval by the support engineer 270 containing the feature (e.g., cases closed in the last week, month, 2 months, 3 months, quarter, 6 months, 1 year, 2 years, 3 years or other time interval). The score generator 225 can generate the case-based skill score using one or more techniques based on the number of closed cases with the feature of the product. The score generator 225 can generate the case-based skill score for each support engineer 270 and each feature of each product, and store the case-based skill scores in the scores data structure 255. As the number of cases containing the feature closed by the support engineer 270 increase, the score generator 225 can increase the case-based skill score for the support engineer 270, in accordance with the case-based skill score function or mapping.

The score generator 225 can generate a skill score (or skill-set score or initial skill score or overall skill score) based on a combination of an audited self-evaluation score and the case-based skill score. The score generator 225 can determine the skill score for each user for each feature of each product. The score generator 225 can determine the skill score based on inputting a support engineer's self-evaluation score for a feature and the support engineer's case-based skill score for the same feature into a function that outputs the skill score. For example, the function can be an average, a weighted average, a sum, a product, or ratio of the self-evaluation score and case-based skill score. The score generator 225 can store the skill score in the scores data structure 255. The scores data structure 255 can include, for each user and each feature of each product, a self-evaluation score (that may be adjusted based on an audit), a case-based skill score, and a skill score that is based on a combination of the self-evaluation score and the case-based skill score. For example, the scores data structure 255 can include one or more of the following fields: {user_identifier; product_identifier; feature_identifier; self-evaluation_score; audited_self-evaluation_score; case-based_skill_score; skill_score}.

The support system 205 can include a case router 230 designed, constructed and operational to route a case to a support engineer 270. The case router 230 can receive a request for support on a product with a feature. The case router 230 can receive the request from a client device 165a associated with a customer 265. The case router 230 can receive the request from an intermediary device or server associated with an entity that provides the product or other developer. The case router 230 can receive the request via network 170. For example, the customer 265 can input or initiate the request using a web-based support portal executed or rendered via client device 165a. The case router 230 can receive the request which can identify a feature of the product selected by the customer 265. The request can indicate the feature of the product for which the customer 265 desires support. The case router 230, responsive to receiving the request identifying the feature of the product, can select a user (e.g., support engineer 270) to support the request based on the skill score of the user for the feature.

The case router 230 can select the support engineer 270 to support the request or assign the case using one or more selection processes, filters, or techniques. For example, the case router 230 can apply an initial filter or selection technique to identify available support engineers 270. The support system 205 can determine which support engineers 270 are currently available, or will be available during a time window for which the customer 265 is requesting support. The request can indicate immediate or real-time support (e.g., as soon as possible), or indicate a time window for when support is desired (e.g., at a specific time, on a specific date, on a specific date at a specific time, in 6 hours, in 12 hours, during the weekend, or some other time window). Based on the time window for support, the support system 205 can identify one or more available support engineers 270 for the request. The support system 205 can ping or poll client devices 165b associated with support engineers 270 to determine their availability. A client application executing on the client device 165b can provide an indication of availability to the support system 205 based on the support engineer 270 indicating they are available, or based on activity on the client device 165b (e.g., mouse or keyboard activity or computer idle). A support application executing on a client device 165b can indicate whether a support engineer 270 is available or unavailable based on whether the support engineer 270 is currently working on an open case or whether the support engineer 270 is on a call with a customer, or other indications of unavailability. The support system 205 can determine whether a support engineer 270 is available based on work hours, a work schedule, or calendar entries. For example, each support engineer 270 may have assigned work hours or a work schedule that indicates when the support engineer 270 is available to handle cases (e.g., Monday-Friday from 9 AM to 5 PM; Thursday-Monday from 12 PM to 8 PM; or other work schedule). The support engineer 270 can have an online calendar that indicates their availability to handle support requests. The support system 205 can determine whether the support engineer 270 is available based on the case status of the last case assigned to the support engineer. For example, if the status of the last case assigned to the support engineer 270 is closed, then the case router 230 can determine that the support engineer 270 is available to receive a new case. If the case router 230 determines that the status of all previously assigned cases to the support engineer 270 is closed, then the case router 230 can determine that the support engineer 270 is available for a new case. In some cases, the status of the case may be open, but can otherwise indicate that the support engineer 270 working on the case is available for a new case (e.g., the case is open, but handed off to another support engineer; the case is open, but in standby or on hold due to other reasons). However, if the support engineer 270 is actively working on a case (e.g., case status is on-going or active), then the case router 230 can determine that the support engineer 270 is unavailable to receive a new case.

Upon identifying available support engineers 270 to handle the case, the case router 230 can apply one or more additional filters to identify a subset of available support engineers 270, or proceed to determining a skill score for the feature of the case for each of the available support engineer 270. In some embodiments, the case router 230 can apply filters such as a geographic-based filter, language-based filter, years of experience-based filters, or other filters. For example, the case router 230 can identify support engineers 270 that are in the same geographic region as the customer 265, that speak the same language as the customer 265, or that have a threshold number of years of experience (e.g., as requested by the customer 265 or other administrator). In some embodiments, the case router 230 may not apply additional filters beyond identifying available support engineers 270.

The case router 230 can select an available support engineer 270 to whom to assign the case based on a skill score (or skill-set score) of the support engineer 270 for the feature of the product indicated in the case. The case router 230 can perform a lookup or otherwise query the scores data structure 255 to retrieve skill scores for available support engineers 270 for a feature of the product corresponding to the request or case. The case router 230 can identify skill scores for one or more support engineers 270, and select a support engineers 270 based on the skill score to respond to the request. The case router 230 can select the support engineer 270 based on the skill score of the support engineer 270 being higher than the skill scores of other available support engineers 270 for the feature of the product.

The case router 230 can use one or more selection techniques to select a support engineer 270. For example, if there are multiple available support engineers 270, the case router 230 can select the support engineer 270 with the highest skill score for the feature of the product corresponding to the request. The case router 230 can use a load balancing technique to select a support engineer 270. For example, if there are multiple available support engineers 270 that are tied (or statistically tied such as within 1%, 2%, 3%, 5% or less difference in skill score), then the case router 230 can use a load balancing technique to select the support engineer 270. in another example, the case router 230 can identify multiple available support engineers 270 having a skill score that is greater than a threshold (e.g., a threshold score for the feature of the product, for the product, for the type of feature, for the customer 265 or other threshold), and use a load balancing technique to select the support engineer 270 to respond to the request.

The case router 230 can be configured with one or more load balancing techniques to select the available support engineer 270 based on the skill score. For example, the case router 230 can use a round robin technique to select support engineers 270 having a satisfactory skill score for the feature of the product in a rotating sequential manner. The case router 230 can use a weighted round robin. For example, if there are multiple available support engineers 270 with a skill score above a threshold but not exactly the same skill score, then the case router 230 can assign each support engineer 270 a weight based on their skill score for the feature. The case router 230 can use a least connection load balancing technique to account for the number of current active cases or number of cases handled during a previous time interval by the support engineer 270 in order to account for the support engineers 270 case load and not over burden a support engineer 270 that may otherwise be selected due to a high skill score for the feature of the product. The case router 230 can use a weighted least connection technique that can differently weight support engineers 270 that may have the same number of active cases, or handled the same number of cases in a previous time interval, based on a skill score of the support engineer 270. The case router 230 can use a response time load balancing technique. For example, the case router 230 can ping each support engineer 270 via client device 165b to determine if the support engineer 270 is available—and use the time the support engineer 270 takes to respond to the ping as the response time for response time load balancing purposes.

The case router 230 can route the request to the selected user (e.g., support engineer 270). The case router 230 can push the request or case to the selected support engineer 270. The case router 230 can transmit an indication of the case identifier and other information associated with the case or request for support from the customer 265 to the support engineer 270 to process, work on, respond, or otherwise address the request for support from the customer 265. The case router 230 can transmit the request or case responsive to selecting the support engineer 270. Responsive to transmitting or routing the request, such as via network 170 to client device 165b, the case router 230 can update a current a status of the case to active or in-progress or otherwise indicate or the flag the case as being open and worked on by the support engineer 270.

The support system 205 can include a survey 220 designed, constructed and operational to receive feedback from the customer 265 regarding the case. The survey 220 can request or receive feedback responsive to closure of the case by the support engineer 270 or the customer 265 or other entity. The feedback can indicate a performance of the support engineer 270 that was assigned to work on the case. The feedback can indicate a skill level of the support engineer 270 working on the case or responding to the request. The survey 220 can refer to or include a survey generator, a survey component, a survey engine or other hardware or software designed and constructed to provide a user interface to a customer 265 to allow a customer 265 to input information regarding the case.

The survey 220 can detect that a case has been closed. A support engineer 270 can mark a case as closed or indicate that the case is complete. The customer 265 can indicate that the case is closed or complete. The customer 265 and support engineer 270 can both indicate that a case has been closed (e.g., the support engineer 270 completed providing support, resolved the issue, or otherwise satisfied the request from the customer 265). Responsive to detecting closure of the case, the survey 220 can request feedback or receive feedback on the case.

For example, the survey 220 can generate a graphical user interface that includes input user interface elements such as an input text box, drop-down button, sliding scale, buttons, or other input mechanism to allow the customer 265 to provide feedback on the case. For example, the customer 265 can input a skill score for the feature of the product based on the performance on the case by the support engineer 270. The survey 220 can receive the skill score from the customer 265, which can include a numerical value, alphanumerical value or other indication of a level of skill with which the support engineer 270 responded to the request from the customer 265.

The survey 220 can receive a skill score from the customer 265 after a case has been closed. The survey 220 can generate an electronic-based survey, such as a questionnaire or prompt, requesting feedback on a feature of the product associated with the case. The electronic-based survey can be presented or provided to the customer 265 responsive to closure of the case. The electronic-based survey can include an indication of the feature of the product corresponding to the case and identified in the request for the support initially received from the customer 265.

For example, the survey 220 can parse the case to identify and extract a feature and product corresponding to the case, and generate a prompt to provide to the customer 265 requesting a skill score for the feature of the product. The survey 220 can identify one or more features of the product by parsing the case information, and request a skill score from the customer 265 for each of the one or more features of the product (or a skill score for each of one or more features of one or more products). The survey 220 can receive a numeric value within a range of numeric values, such as a range from 0 to 10, where 0 can represent a low quality of support provided by the support engineer 270 with regard to the feature of the product, and 10 represents a high quality of support provided by the support engineer 270 with regard to the feature of the product. The customer 265 can provide, to the survey 220, a rating or skill score based on the level of support quality from the support engineer 270 assigned to the case 250 after the case 250 has been closed.

The survey 220 can receive a customer-based skill score of the user (e.g., support engineer 270) associated with the request. The customer-based skill score can include a score in a format that is similar to the format of the self-evaluation skill score initially provided by the support engineer 270 for the feature of the product. The customer-based skill score can include a score in a format that is similar to the format of the skill score stored in the scores data structure 255 in data repository 240. The survey 220 can store the customer-based skill score in the scores data structure 255, or provide the customer-based skill score to the score generator 225 to update the skill score for the support engineer 270 for the feature of the product.

In some embodiments, the survey 220 can provide a questionnaire that includes questions related to the performance of the support engineer 270 that worked on or closed the case. Questions can include, for example: Did the support engineer 270 address the issue for the feature raised in the request?; Did it appear that the support engineer 270 had previous experience with this feature of the product?; Did the support engineer 270 solve the issue with the feature in a timely or efficient manner?; Did the support engineer 270 promptly resolve the issue with the feature?; What was level of difficulty of the issue with the feature?; Did the support engineer 270 have to refer you to other support engineer 270 that were more knowledgeable about the feature?; or What skill score would you provide for the support engineer 270 with regard to the feature of the product? The survey 220 can analyze the responses to the questions, which can include binary responses from the customer 265 (e.g., yes or no), text, or phrases. The survey 220 can determine a customer-based skill score for the support engineer 270 based on the responses to the questionnaire. For example, the survey 220 can generate a higher skill score if the customer 265 indicated that the support engineer 270 solved the issue with the feature of the product in a prompt or timely manner, or if the customer 265 indicated that the support engineer 270 efficiently solved the issue, or if the customer 265 indicated that the support engineer 270 had previous experience with this feature. The survey 220 can generate a lower skill score if the customer 265 indicated the opposite to these survey questions.

The score generator 225 can update the skill score for the support engineer 270 for the feature of the product responsive to receiving the customer-based skill score from the customer 265 that is requested by the survey 220 responsive to closure of the case. The score generator 225 can update the skill score of the feature of the product stored in the scores data structure 255 for the support engineer 270. The score generator 225 may only update the relevant score without modifying or manipulating other scores of the support engineer 270 that are associated with unrelated features of products, thereby reducing data processing and manipulation computing processes.

The score generator 225 can update the skill score for the support engineer 270 using one or more techniques. The score generator 225 can update the skill for the support engineer 270 by combining the skill score stored in the scores data structure 255 for the feature of the product with the customer-based skill score received from the survey 220. The score generator 225 can combine the scores based on a function or other techniques. The score generator 225 can combine the scores in a manner similar to the combining the self-evaluation score with the case-based skill score for each feature. The score generator 225 can combine the scores based on an average, weighted average, or other function.

The score generator 225 can update the skill score based on the number of cases. For example, the score generator 225 can determine an updated case-based skill score in a manner similar to how the score generator 225 generated the initial case-based skill score (e.g., based on the number of cases closed by the support engineer 270 with the feature of the product). The score generator 225 can update the skill score based on the updated case-based skill score. For example, the case-based skill score can increase as a result of the support engineer 270 closing the case. However, in some cases, the case-based skill score may not change if the support engineer 270 was unable to successfully close the case (e.g., the support engineer 270 could not resolve the issue and transferred the case to another support engineer 270 or a technical lead 280 for resolution). In some cases, the case-based skill score may decrease if the support engineer 270 was unsuccessful in closing the case. Thus, in some embodiments, responsive to closure of the case by the support engineer 270, the score generator 225 can update the skill score for the support engineer 270 for the feature of the product based on a customer-based skill score and a case-based skill score.

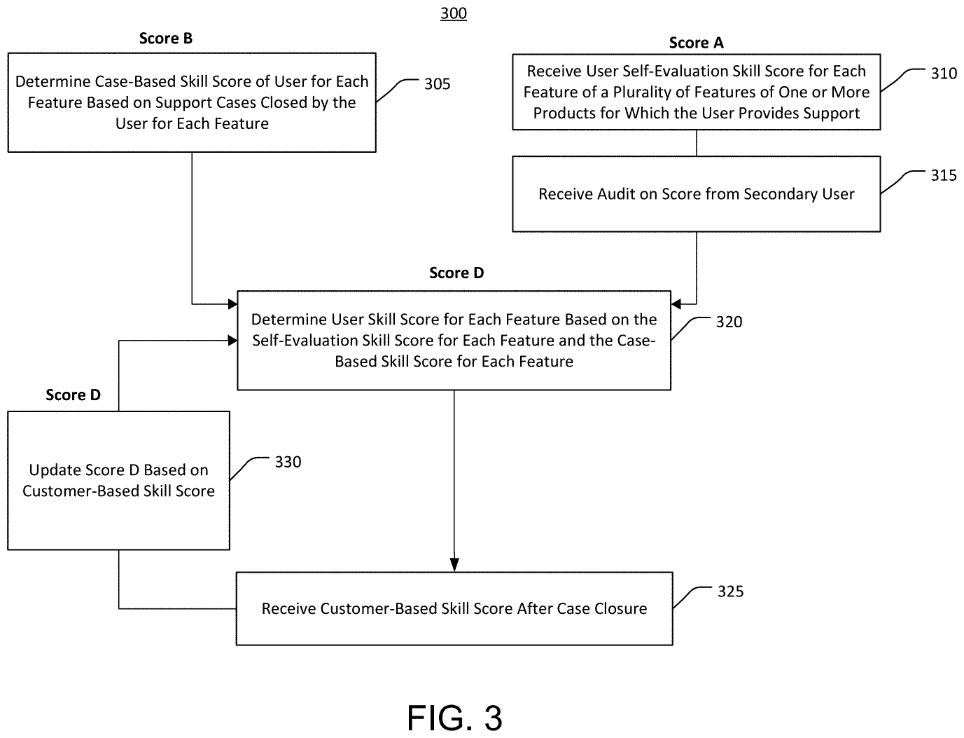

FIG. 3 depicts an example flow diagram of a method for determining a skill score for routing support cases. The method 300 can be performed using one or more system, component or functionality depicted in FIGS. 1A, 1B or 1C, including, for example, a support system, self-evaluator, auditor, score generator, survey, server, or client device. One or more aspects of functions of the method 300 can be performed or be otherwise associated with a user (e.g., a support engineer), a customer, and a second user (e.g., a technical lead). In brief overview, the method 300 can include the support system determining a case-based skill score at 305. At 310, the support system can receive a user self-evaluation skill score. At 315, the support system can receive an audit on the self-evaluation score. At 320, the support system can determine a user skill score based on the case-based skill score, self-evaluation skill score and audit. At 325, the support system can receive a customer-based skill score after closure of a case. At 330, the support system can update the skill score (e.g., score D) based on the customer-based skill score.

Still referring to FIG. 3, and in further detail, the method 300 can include the support system determining a case-based skill score at 305. The support system can determine the case-based skill score for a particular user for a particular feature of a particular product. The support system can determine a case-based skill score for each user, for each feature and for each product. The support system can determine the case-based skill score based on skill history or historical case activity of the user. The support system can determine the case-based skill score by identifying the number of cases closed by the support engineer that relate to a feature for a product. The support system can generate the case-based skill score for the user, feature and product based on the number of cases closed by the user for the feature and product. The support system can generate the case-based skill score in real-time, in a batch process, periodically, based on a time interval, or responsive to a condition, trigger or event (e.g., responsive to a customer request, responsive to the user becoming available, responsive to a new user being associated with the system, etc.) The case-based skill score can be referred to as Score B. The support system can access one or more data structures stored in one or more data repositories to determine the case history and store Score B.

At 310, the support system can receive a user self-evaluation skill score. The self-evaluation sill score can be for a particular user, feature and product. The support system can receive or determine the self-evaluation skill score based on the user performing a self-evaluation. The self-evaluation can include the user inputting or providing a skill score for a particular feature of a particular product. The user can access a user interface provided by the support system to select a feature and product, and then indicate the self-evaluation score. The user can provide the self-evaluation for one or more features of one or more product. In some cases, the support system can determine, based on the case history, which features and products the user has previously worked on or has experience with, and only allow the user to input a self-evaluation score for those features, which may reduce computing resource utilization. In some cases, the support system can allow the user to enter a self-evaluation score for all available features and products. The support system can access one or more data structures stored in one or more data repositories to determine the list of features and products.

At 315, the support system can receive an audit on the self-evaluation score. The support system can provide the self-evaluation score received at 310 to a second user (e.g., a technical lead or other supervisor) in order to audit, review, monitor or otherwise validate the self-evaluation score provided by the user at 310. The support system can transmit or forward the self-evaluation scores for each user, feature and product to a computing device associated with the second user to allow the second user to approve the self-evaluation score, reject the self-evaluation score, modify the self-evaluation score, or return the self-evaluation score to the user to allow the user to re-enter a new self-evaluation score. The audited self-evaluation score can be referred to Score A. The support system can store the audited self-evaluation score for each user, feature and product in one or more data structures of one or more data repositories.

At 320, the support system can determine a user skill score based on the case-based skill score, self-evaluation skill score and audit. The support system can combine, for each user, feature, and product, Score A and Score B. For example, the support system can combine the case-based skill score with the audited self-evaluation score to generate a user skill score (or skill score or skill-set score). The support system can use one or more techniques or functions to combine Score A with Score B to generate the user skill score, including, for example, an average, weighted average, sum, or product. The support system can store Score D for each user, feature and product in one or more data structures of one or more data repositories.

At 325, the support system can receive a customer-based skill score after closure of a case. The support system can receive the customer-based skill score responsive to closure of a case. The support system can detect the closure of the case and prompt the customer for a customer-based skill score for a feature of a product related to the case. The customer can provide one or more customer-based skill scores depending on the number of features or products associated with the case. The support system can receive the customer-based skill score responsive to a survey, questionnaire, or other prompt to the customer. The support system can analyze, process or otherwise parse the feedback from the customer to generate the customer-based skill score, or the customer can provide a skill score having the same format and within the same range as Scores A and B. The support system can store the customer-based skill score in one or more data structures of one or more data repositories.

At 330, the support system can update the skill score (e.g., score D) based on the customer-based skill score. The support system can update Score D responsive to closure of the case and receiving the customer-based skill score from the customer. The support system can update Score D using one or more techniques or functions, such as taking an average, weighted average, sum, product, or other technique. For example, the support system can increase Score D by a predetermined value if the customer-based skill score is greater than Score D or greater than Score D by a threshold. The support system can decrease Score D by a predetermined value of the customer-based skill score is less than Score D, or less than Score D by a threshold. If the customer-based skill score is the same as Score D, or a negligible difference (e.g., within 1%, 2%, 3%, 4%, 5% or less), then the support system can determine not to increase or decrease Score D.

The support system can determine to update Score D at 330 based on an updated case-based skill score. For example, successful closure of the case by the user can result in an increase to the case-based skill score. The support system can update Score D at 330 based on the increase to case-based skill score based on the increase to the number of successfully closed cases having the feature of the product by the user. Thus, the support system can update Score D based on both a customer-based skill score and an updated case-based skill score.

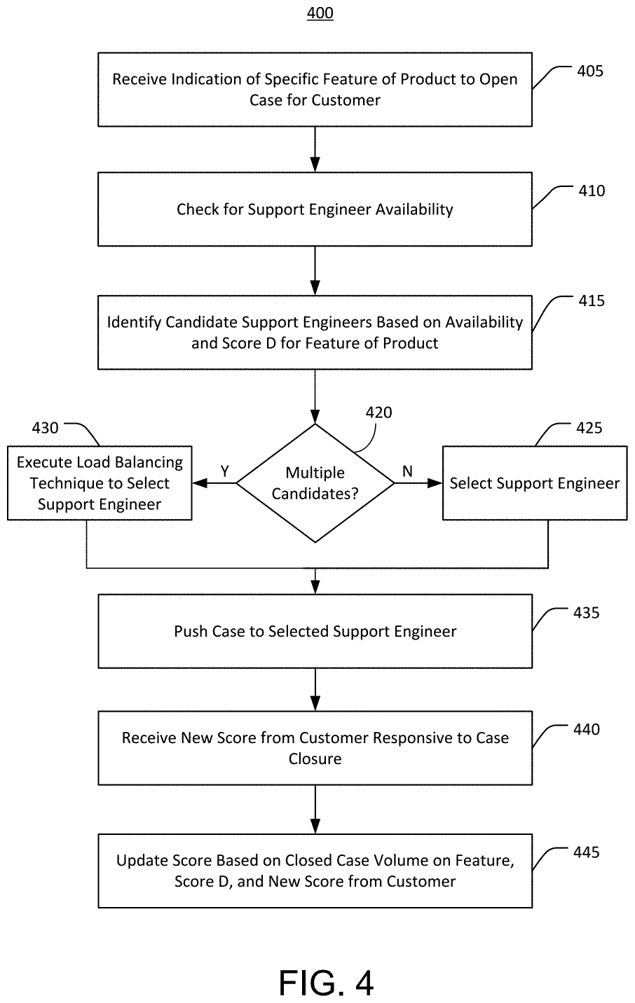

FIG. 4 depicts an example flow diagram of a method for updating a skill score used for routing support cases. The method 400 can be performed using one or more system, component or functionality depicted in FIGS. 1A, 1B or 1C, including, for example, a support system, self-evaluator, auditor, score generator, survey, server, or client device. One or more aspects of functions of the method 400 can be performed or be otherwise associated with a user (e.g., a support engineer), a customer, and a second user (e.g., a technical lead). In brief overview, the method 400 can include receiving an indication of a specific feature of a product to open a case for a customer at 405. At 410, the support system can check for support engineer availability. At 415, the support system can identify candidate support engineers based on availability and Score D for the feature of the product of the case. At 420, the support system can determine whether there are multiple candidate support engineers to whom to push the case. If there is only one candidate support engineer, the support system can proceed to 425 to select the support engineer. However, if there are multiple candidates, the support system can proceed to 430 to execute a load balancing technique to select the support engineer. At 435, the support system can push the case to the support engineer. At 440, the support system can receive a new score from the customer responsive to case closure. At 445, the support system can update Score D based on the case-closed volume and new score received from the customer.

Still referring to FIG. 4, and in further detail, the support receives an indication of a specific feature of a product to open a case for a customer at 405. The support system can provide a user interface that is executed on a computing device associated with the customer. The customer can use one or more user interface elements to indicate a feature of the product to open the case. The customer can provide text, voice input, button selection, gestures, or other indications that the support system can receive, process or parse to determine a feature of a product for which the customer requests support. The customer can request support due to an issue, fault, bug, error, or other help with a feature of a product associated with information technology infrastructure, such as hardware or software. The customer can request regular maintenance, upgrades, new versions, or other support. The support system can receive the request and indication of the feature of the product, and initiate opening a case to provide support responsive to the request.

At 410, the support system can check for support engineer availability. The support system can identify one or more support engineers that are available. The support system can identify available support engineers using various techniques, functions or components. For example, the support system can identify available support engineers based on work schedules of the support engineers, calendar entries, or current case status (e.g., actively working on a case or recently closed a case). The support system can identify available support engineers by pinging or transmitting a request to computing devices associated with the support engineers to provide an indication of their availability. Support engineers can indicate they are available by flagging or marking their availability status in support application. In some cases, if the requested support is for a later time as opposed to real-time, the support system can determine the availability of the support engineers for the requested support time window by using a work schedule or calendar entries.

At 415, the support system can identify candidate support engineers based on availability and Score D for the feature of the product of the case. The support system can determine Score D for each of the available support engineers and compare Score D with a threshold score or minimum score (e.g., a score greater than zero, 1, 2, 3, 4, 5, 10, 15, 20, 25, 30, 40, 50, 60, 70 or other score). The threshold or minimum score can be a predetermined fixed value, a dynamic value, percentage, vary based on the type of feature, vary based on the number of available candidate support engineers, vary based on the range scores or other statistical metric of the available support engineers. For example, candidate support engineers can include support engineers that are available and have a Score D that fall within a certain percentile of available support engineers or support engineers having a non-zero Score D for the feature (e.g., top 10 percent of available support engineers, top 25 percent of available support engineers, top 35 percent, top 40 percent, top 50 percent, or other percentile of available support engineers).

At 420, the support system can determine whether there are multiple candidate support engineers to whom to push the case. For example, the support system can determine that there are multiple candidate support engineers that are available if there is more than one support engineer that is available and has a Score D for the feature of the product that falls within the top 25% of available support engineers. In another example, the support system can determine there are multiple available candidate support engineers if their Score D is greater than a threshold for the feature of the product. The support system can determine there is only one candidate support engineer that is available if there is only one available support engineer that has a non-zero Score D, or Score D greater than a threshold, or Score D in the top 10 percentile, for example. If the support system determines there is only one available candidate support engineer, the support system can proceed to 425 to select the only candidate support engineers to route the case.

However, if the support system determines at 420 that there are multiple candidate available support engineers, the support system can proceed to 430 to execute a load balancing technique to select the support engineer. The support system can select one or more load balancing techniques, such as round robin, weighted round robin, least connections or other load balancing techniques to select a support engineer from the multiple candidate support engineers to whom to route the case.

Upon selecting a support engineer at 430, the support system can proceed to 435 to push the case to the support engineer. The support system can identify a computing device identifier or account identifier associated with the selected support engineer, and transmit, route, push, or otherwise provide the case to the support engineer via network. For example, the support system can provide an electronic notification to a computing device linked or associated with the selected support indication. The notification can include an indication of the new case or request from the customer (e.g., a case number or identifier), and a request or instruction to work on the case. The notification can include an indication of the feature of the product or other information associated with the case that facilitates resolution of the case.

At 440, the support system can receive a new score from the customer responsive to case closure. The support system can receive an indication that the support engineer closed the case. The support system can receive the indication of case closed from the customer, the support engineer or both. The support system can provide an electronic survey, prompt or other form requesting feedback from the customer on the case. The customer can input a customer-based skill score for the feature of the product associated with the case into the electronic survey, prompt or other user interface. The support system can process, analyze, parse or otherwise determined the customer-based skill score responsive to receiving feedback from the customer responsive to closing of the case.

At 445, the support system can update Score D based on the case-closed volume and new score received from the customer. The support system can update Score D for the support engineer, feature and product responsive to receiving the feedback from the customer and based on a case-closed volume. The case-closed volume may increase due to the new case closure, which may positively impact Score D. The customer-based skill score may positively or negatively impact Score D. The support system can update Score D for the support engineer, feature and product using various techniques or functions.

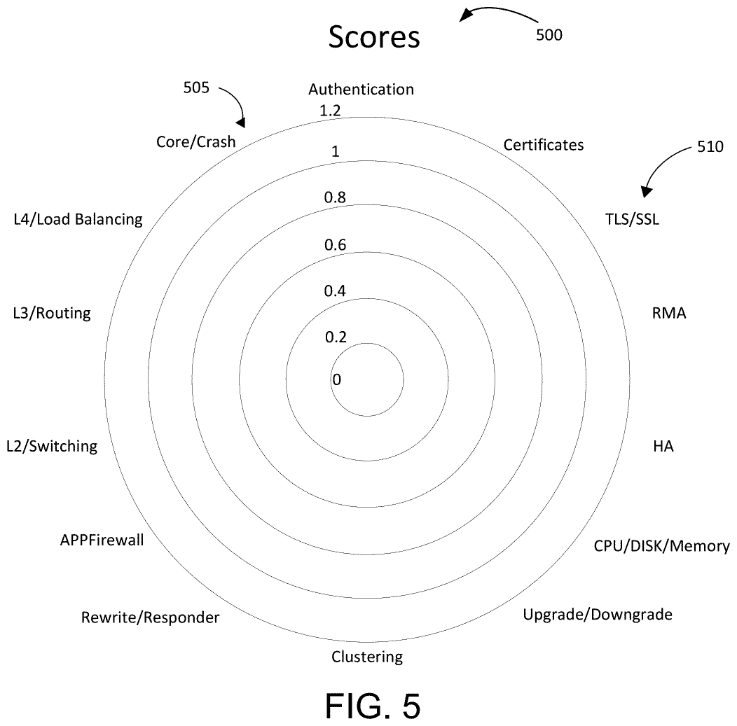

FIG. 5 depicts an example block diagram of score legend, in accordance with an embodiment. The example score legend 500 can include a score value range 505 that includes a range of values 505 starting from 0 to 1.2, incrementing by a value of 0.2 on the score legend, for example. The score legend can include one or more product features 510 for an ADC product, such as Authentication, Certificates, TLS/SSL, RMA, HA, CPU/DISK/Memory, Upgrade/Downgrade, Clustering, Rewrite/Responder, APPFirewall, L2/Switching, L3/Routing, L4/Load Balancing, and Core/Crash.

The score legend 500 can include a range of values corresponding to various features of a product. The score legend 500 can be in the form of a chart or graph, such as a radar graph. The score legend 500 can include various score values that provide an indication of the skill level of the support engineer across multiple features of a particular product (e.g., an ADC). The score legend 500 can illustrate one or more of a case-based score for one or more features of a product for the support engineer, a self-evaluation score for one or more features of the product for the support engineer, an audited self-evaluation score for one or more features of the product for the support engineer, a Score D for one or more features of the product for the support engineer, a customer-based score for one or more features of the product for the support engineer, or other score for one or more features of the product for the support engineer.

The support system can generate the score legend 500 (or score map) using a mapping protocol or component to graph skill scores for features of a product for a support engineer and render a graphical illustration of the score map for the support engineer for display on a computing device. The support system can generate and render an interactive graphical illustration of the score map for the support engineer for display on a computing device. The support system can generate and render a dynamic graphical illustration of the score map for the support engineer for display on a computing device that can be dynamically updated as the support systems receives new scores or updates scores for the features of the product for the support engineer (e.g., a real-time update to the score map based on cases closed by the support engineer for the features of the product).

The support system can provide the score map to the support engineer or a technical lead that is auditing the support engineer. For example, subsequent to a self-evaluation process, the support system can initiate an audit process in which the support system generate a score map including self-evaluation scores for each feature of the product, and transmit the score map to the technical lead to facilitate auditing the self-evaluation scores. The technical lead can approve or reject the entire score map, or one or more scores for one or more features on the score map. The technical lead can adjust, modify or manipulate one or more scores on the score map. The technical lead can flag one or more scores on the score map for return to the support engineer to provide a new self-evaluation score for the one or more features.

The score value range 505 can include a rating system to determine the level of quality of service a support engineer 270 provides. The score value range 505 can include a range of numeric values starting from 0 to 1.2, incrementing by 0.2, where 0 is the lowest quality of service and 1.2 is the highest quality of service by a support engineer 270. The score value of range 505 may indicate the level of quality of support from a support engineer 270.

Referring to 510, and in some embodiments, the product features 510 can include a multiple features labeled on a chart or graph. The product features 510 can be for a product, such as an ADC, and list feature such as Authentication, Certificates, TLS/SSL, RMA, HA, CPU/DISK/Memory, Upgrade/Downgrade, Clustering, Rewrite/Responder, APPFirewall, L2/Switching, L3/Routing, L4/Load Balancing, and Core/Crash retrieved from a features data structure stored in a data repository.

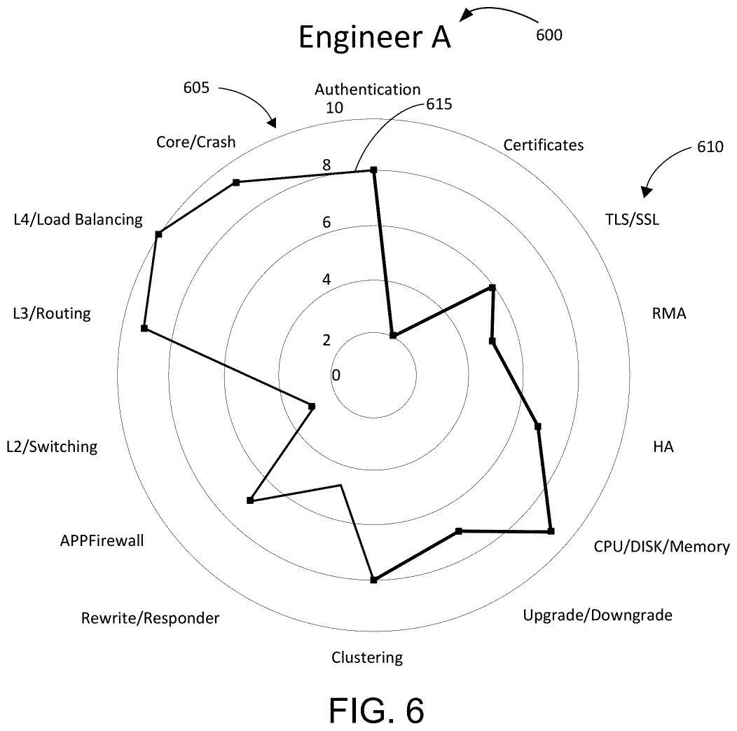

FIG. 6 depicts an example block diagram of a skill-set score for a support engineer. The support system can generate a score map 600 for the support engineer A that includes scores for multiple features of a product. The support system can generate a single score map that includes scores for each feature of a product. The scores can refer to one or more of a skill score (e.g., Score D), an audited self-evaluation score (e.g., Score A), a case-based score (e.g., Score B), or a customer-based score. The support system can map or graph one or more types of scores on a single score map using different icons, symbols, or colors, for example. The support system can map or graph the latest Score D for each feature of a product. In the event the product includes a number of features that cannot be effectively displayed on the score map 600, the support system can determine to adjust or modify the score map, select a different type of score map, or select a subset of features for the score map (e.g., features that were most recently updated, commonly used features, high priority features, or a predetermined list of selected features to graph on the score map).

The skill-set score for engineer A (e.g., a user or support engineer) can include a range of values 605 to determine a spread of data 615 that may be used to indicate the level of skill of the support engineer A for features 610 of a product. The range of values 605 can include whole numbers beginning from 0 and ending in 10, incrementing by a value of 2. The specific features 610 of the product can include Authentication, Certificates, TLS/SSL, RMA, HA, CPU/DISK/Memory, Upgrade/Downgrade, Clustering, Rewrite/Responder, APPFirewall, L2/Switching, L3/Routing, L4/Load Balancing, and Core/Crash. The spread of data 615 on the score map 600 can depict engineer A as skillful in the features 610 “Authentication” with a score of 10 and “Core/Crash” and “CPU/DISK/Memory” with a score of 8.

The score value range 605 can include a rating system to determine the level of quality of service a support engineer provides. The score value range 605 can include a range of numeric values starting from 0 to 10, incrementing by 2, where 0 is the lowest quality of service and 10 is the highest quality of service provided by a support engineer. The score value of range 605 may determine the level of quality of support from a support engineer.

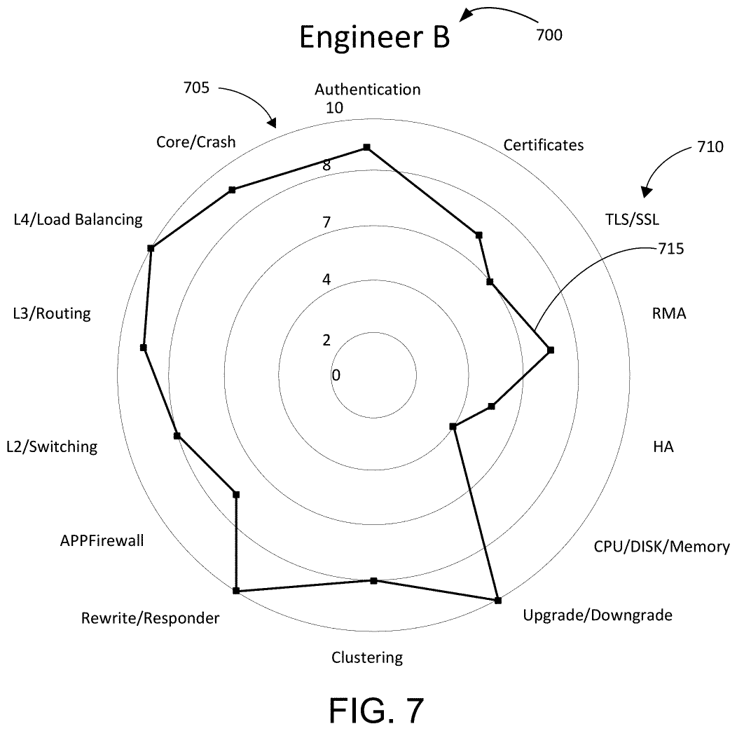

FIG. 7 depicts an example block diagram of a skill-set score for a support engineer. The support system can generate a score map 700 for the support engineer B that is similar to the score map 600 generated for engineer A, but with score corresponding to engineer B. The score map 700 can includes scores for multiple features of a product. The support system can generate a single score map that includes scores for each feature of a product. The scores can refer to one or more of a skill score (e.g., Score D), an audited self-evaluation score (e.g., Score A), a case-based score (e.g., Score B), or a customer-based score. The support system can map or graph one or more types of scores on a single score map using different icons, symbols, or colors, for example. The support system can map or graph the latest Score D for each feature of a product. In the event the product includes a number of features that cannot be effectively displayed on the score map 700, the support system can determine to adjust or modify the score map, select a different type of score map, or select a subset of features for the score map (e.g., features that were most recently updated, commonly used features, high priority features, or a predetermined list of selected features to graph on the score map).

The score map 700 includes a range of values 705 to determine a spread of data 715 that that can indicate the level of skill the support engineer B has in features 710 of a product. The range of values 705 can include whole numbers beginning from 0 and ending in 10, incrementing by a value of 2. The specific features 710 on a product may include Authentication, Certificates, TLS/SSL, RMA, HA, CPU/DISK/Memory, Upgrade/Downgrade, Clustering, Rewrite/Responder, APPFirewall, L2/Switching, L3/Routing, L4/Load Balancing, and Core/Crash. The spread of data 715 on the skill-set score 700 may depict engineer B as skillful in the features 710 “Core/Crash”, “RMA”, and “Clustering” with a score of 8 for each.

Various elements, which are described herein in the context of one or more embodiments, may be provided separately or in any suitable subcombination. For example, the processes described herein may be implemented in hardware, software, or a combination thereof. Further, the processes described herein are not limited to the specific embodiments described. For example, the processes described herein are not limited to the specific processing order described herein and, rather, process blocks may be re-ordered, combined, removed, or performed in parallel or in serial, as necessary, to achieve the results set forth herein.

It will be further understood that various changes in the details, materials, and arrangements of the parts that have been described and illustrated herein may be made by those skilled in the art without departing from the scope of the following claims.

We claim:

1. A method for determining a skill score for routing support cases, the method comprising:
(a) receiving, by a device via a user interface, a self-evaluation skill score of a user for each feature of a plurality of features of one or more products for which the user provides support;
(b) identifying, by the device, a number of support cases handled by the user from a plurality of support cases handled by a plurality of users and that comprise each feature and have a status of closed;
(c) determining, by device, a case-based skill score of the user for each feature based at least on the number of support cases that are closed by the user for each feature;
(d) determining, by the device, a skill score of the user for each feature based on at least the self-evaluation skill score of the user for each feature and the case-based skill score of the user for each feature;
(e) selecting, by the device responsive to receiving a request for support on a product of the one or more products with a feature of the plurality of features, the user from a plurality of users to support the request based at least on the skill score of the user for the feature; and
(f) routing, by the device, the request to the user.

2. The method of claim 1, wherein (a) further comprises receiving, by the device, via the user interface, one of a confirmation or a modification of the self-evaluation skill score of the user for each feature as a result of an audit of the self-evaluation score of the user by a second user.

3. The method of claim 2, wherein the user is one of a support engineer or a technical support person and the second user is one of a supervisor or a technical lead to the user.

4. The method of claim 1, wherein the case-based skill score for each feature is increased by an increase in the number of cases comprising the feature closed by the user.

5. The method of claim 1, further comprising receiving, by the device, a customer-based skill score of the user for the customer from the customer associated with the request.

6. The method of claim 5, wherein the customer-based skill score is received via an electronic-based survey presented to the customer responsive to closing the case.

7. The method of claim 5, further comprising updating, by the device, the skill score of the user based at least on the customer-based skill score.

8. The method of claim 1, wherein (e) further comprises selecting, by the device, the user based on the skill score being higher than one or more skill scores of one or more other users of the plurality of users for the feature and availability of the user.

9. The method of claim 1, wherein (e) further comprises receiving, by the device, the request identifying the feature of the product selected by the customer from the plurality of features.

10. The method of claim 1, further comprising updating, by the device, the skill score of the user responsive to both the number of cases comprising the feature closed by the user and changes to the customer-based skill score received by customers associated with the number of cases.

11. A system for determining a skill score for routing support cases, the system comprising:
a device comprising one or more processors, coupled to memory and configured to:
receive, via a user interface, a self-evaluation skill score of a user for each feature of a plurality of features of one or more products for which the user provides support;
identify a number of support cases handled by the user from a plurality of support cases handled by a plurality of users and that comprise each feature and have a status of closed;
determine a case-based skill score of the user for each feature based at least on the number of support cases that are closed by the user for each feature;
determine a skill score of the user for each feature based on at least the self-evaluation skill score of the user for each feature and the case-based skill score of the user for each feature;
select, responsive to receiving a request for support on a product of the one or more products with a feature of the plurality of features, the user from a plurality of users to support the request based at least on the skill score of the user for the feature; and
route the request to the user.

12. The system of claim 11, wherein the device is further configured to receive, via the user interface, one of a confirmation or a modification of the self-evaluation skill score of the user for each feature as a result of an audit of the self-evaluation score of the user by a second user.

13. The system of claim 12, wherein the user is one of a support engineer or a technical support person and the second user is one of a supervisor or a technical lead to the user.

14. The system of claim 11, wherein the case-based skill score for each feature is increased by an increase in the number of cases comprising the feature closed by the user.

15. The system of claim 11, wherein the device is further configured to receive a customer-based skill score of the user for the customer from the customer associated with the request.

16. The system of claim 15, wherein the customer-based skill score is received via an electronic-based survey presented to the customer responsive to closing the case.

17. The system of claim 15, wherein the device is further configured to update the skill score of the user based at least on the customer-based skill score.

18. The system of claim 11, wherein the device is further configured to select the user based on the skill score being higher than one or more skill scores of one or more other users of the plurality of users for the feature and availability of the user.

19. The system of claim 11, wherein the device is further configured to receive the request identifying the feature of the product selected by the customer from the plurality of features.

20. The system of claim 11, wherein the device is further configured to update the skill score of the user responsive to both the number of cases comprising the feature closed by the user and changes to the customer-based skill score received by customers associated with the number of cases.
